(19) United States
(12) Patent Application Publication
(10) Pub. No.: US 2009/0133088 A1
(43) Pub. Date: May 21, 2009

(54) Method and system for IPTV service authentication and service quality control

(75) Inventors: Sun-me Kim, Daejeon-si (KR); You-hyeon Jeong, Daejeon-si (KR); Kyeong-ho Lee, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Electronics and Telecommunications Research Institute

(21) Appl. No.: 12/157,421

(22) Filed: Jun. 10, 2008

(30) Foreign Application Priority Data
Nov. 20, 2007 (KR) 10-2007-0118657

(51) Int. Cl. H04N 7/173

(52) U.S. Cl. 725/116

(57) ABSTRACT

Provided are a method of and system for controlling IPTV service authentication and traffic flow in an access network. The IPTV service system comprises: a subscriber concentrator which delivers an IPTV service request message that is sent from a subscriber terminal, receives an IPTV service authentication reply message generated in accordance with IGMP in response to the IPTV service request message, and sends a corresponding IPTV multicast stream to the subscriber terminal according to an IPTV service authentication result; a network connector which receives the IPTV service request message delivered from the subscriber concentrator, generates an IPTV service authentication request message in accordance with a RADIUS protocol, sends the generated IPTV service authentication request message to an IPTV service authentication/billing server, generates an IPTV service authentication reply message in accordance with the IGMP when receiving an IPTV service authentication reply message generated in accordance with the RADIUS protocol, and sends the generated IPTV service authentication reply message to the subscriber concentrator; and the IPTV service authentication/billing server which determines whether the subscriber is authorized for an IPTV service when receiving the IPTV service authentication request message that is generated in accordance with the RADIUS protocol and sent from the network connector, and generates the IPTV service authentication reply message in accordance with the RADIUS protocol and sends the IPTV service authentication reply message to the network connector. Accordingly, resources of the access network can be used effectively.

### CROSS REFERENCE TO RELATED APPLICATIONS

This application claims priority from Korean Patent Application No. 10-2007-0118657, filed on Nov. 20, 2007, the disclosure of which is incorporated herein in its entirety by reference.

### BACKGROUND OF THE INVENTION

1. Field of the Invention

The present invention relates to Internet protocol based TV (IPTV) service technology in an access network, and more particularly, to a method and a system for authenticating IPTV service and ensuring the IPTV service quality.

This work was partly supported by the IT R&D program of Ministry of Information and Communication (MIC)/Institute for Information Technology Advancement (IITA) [2005-S-097-03, Development of BcN Integrated Network Control and QoS/TE Management Technology].

2. Description of the Related Art

Conventionally, a conditional access system (CAS) is used for authentication of Internet protocol television (IPTV) service. A CAS uses a key for service authentication, allowing only valid subscribers' terminals to decode received IPTV streams. Such the CAS is useful to authenticate the IPTV service, but not the subscriber. However, in a CAS, authentication is performed in a terminal of a subscriber, and it is impossible to prevent IP traffic from being transmitted to unauthorized terminals. Therefore, traffic efficiency in the access network deteriorates.

### SUMMARY OF THE INVENTION

The present invention provides a method and a system for improving a method of Internet protocol television (IPTV) service authentication.

The present invention further provides a method and a system for using resources of an access network most effectively by controlling traffic flow with respect to authenticated IPTV service.

Additional aspects of the invention will be set forth in the description which follows, and in part will be apparent from the description, or may be learned by practice of the invention.

The present invention discloses an Internet protocol television (IPTV) service method which is performed by a network connector that is a part of an access network, the IPTV service method comprising: receiving an IPTV service request message from a subscriber; generating an IPTV service authentication request message using a RADIUS protocol in response to the IPTV service request message; requesting IPTV authentication by sending the generated IPTV service authentication request message to an IPTV service authentication/billing server according to the RADIUS protocol; and receiving an IPTV service authentication response message from the IPTV service authentication/billing server according to the RADIUS protocol in response to the authentication request.

The generating of the IPTV service authentication request message may comprise: including a source IP address of a subscriber and a multicast group IP address, which are written in the IPTV service request message, in the IPTV service authentication request message.

The IPTV service method may further comprise: receiving an IPTV service stop request message from a subscriber; collecting accounting information for the corresponding subscriber; generating an accounting message including the collected accounting information using RADIUS protocol; and requesting the IPTV service authentication/billing server to process billing by sending the generated accounting message according to the RADIUS protocol.

The present invention also discloses an IPTV service method which is performed by an IPTV service authentication/billing server that performs subscriber authentication and billing process for an IPTV service, the IPTV service method comprising: receiving an IPTV service authentication request message which is generated using RADIUS protocol and sent from a network connector; determining whether the subscriber is authorized for the IPTV service in response to the IPTV service authentication request of the received message; and sending the determined authentication result to the network connector using the RADIUS protocol.

The determining whether the subscriber is authorized may comprise identifying a subscriber that requests the IPTV service; searching for channel information of the authenticated IPTV service; and determining whether the subscriber is authorized for the IPTV service by searching an IPTV service usage right relating information table based on subscriber identification information and the searched channel information.

The present invention also discloses an IPTV service method which is performed by a subscriber concentrator that is a part of an access network, the IPTV service comprising: receiving an IPTV service authentication reply message generated using an Internet group management protocol (IGMP) from a network connector; analyzing the received IPTV service authentication reply message; sending a corresponding IPTV multicast stream to a corresponding subscriber terminal when the analyzed message indicates authentication success; and stopping the corresponding IPTV multicast stream from being sent to the corresponding subscriber terminal when the analyzed message indicates authentication failure.

The present invention also discloses an IPTV service system comprising: a subscriber concentrator which delivers an IPTV service request message that is sent from a subscriber terminal, receives an IPTV service authentication reply message generated in accordance with IGMP in response to the IPTV service request message, and sends a corresponding IPTV multicast stream to the subscriber terminal according to an IPTV service authentication result; a network connector which receives the IPTV service request message delivered from the subscriber concentrator, generates an IPTV service authentication request message in accordance with a RADIUS protocol, sends the generated IPTV service authentication request message to an IPTV service authentication/billing server, generates an IPTV service authentication reply message in accordance with the IGMP when receiving an IPTV service authentication reply message generated in accordance with the RADIUS protocol, and sends the generated IPTV service authentication reply message to the subscriber concentrator; and the IPTV service authentication/billing server which determines whether the subscriber is authorized for an IPTV service when receiving the IPTV service authentication request message that is generated in accordance with the RADIUS protocol and sent from the network connector, and generates the IPTV service authentication reply message in accordance with the RADIUS protocol and sends the IPTV service authentication reply message to the network connector.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 shows a schematic configuration of a network related to the present invention.

FIG. 2 is a diagram showing the whole procedure of how to perform IPTV service authentication and service quality control in the network in FIG. 1 according to an embodiment of the present invention.

FIG. 3 is a flowchart illustrating how the subscriber concentrator performs IPTV service authentication and IPTV service quality control according to an embodiment of the present invention.

FIG. 4 is a flowchart illustrating how the network connector which acts as an IGMP router authenticates and controls IPTV service quality.

FIG. 5 is a flowchart illustrating how the IPTV service authentication/billing server 700 processes the IPTV service authentication and the IPTV service quality control according to an embodiment of the present invention.

FIGS. 6 to 8 illustrate tables required for the IPTV service authentication and the IPTV service quality control.

### DETAILED DESCRIPTION OF EXEMPLARY EMBODIMENTS

In an access network, an Internet group management protocol (IGMP) router and an IGMP snooper are employed to use IPTV service. The IGMP router is normally a three-layer router, and requests or cancels receipt of IP multicast traffic from a host (a subscriber) in the access network through the use of a multicast routing protocol. The IGMP snooper is usually a two-layer switch, and copies a multicast stream transmitted from the IGMP router and transmits the copied multicast stream to n subscriber terminals that request the IPTV service.

The IGMP router processes IPTV service authentication. However, even though the IGMP router authenticates IPTV service, since substantially the IGMP snooper sends the IPTV multicast stream to the subscriber, the IGMP router needs to pass the authentication result to the IGMP snooper. That is, exchange of control information between a three-layer router device and a two-layer switch device is necessary.

With respect to the exchange of control information, international standard organizations such as the DSL Forum have defined a multicast transaction protocol known as GSMPv3 through the use of an access node control protocol (ANCP). However, while such a method using ANCP does not burden a device such as an IGMP router which employs various software, a lower layer switch, that is, an IGMP snooper of two layers cannot meet the high software requirements for this method. Therefore, this method is not suitable for information exchange between the IGMP snooper and the IGMP router.

Hence, to solve the problems described above, the present invention provides a method and a system which allow a three-layer router device to authenticate an IPTV service, enable an exchange of information regarding the IPTV service authentication result between the three-layer router device and a two-layer switch device, and control traffic flow for the IPTV service according to the authentication result in order to effectively use resources of an access network.

Hereinafter, the present invention will be described in detail by explaining preferred embodiments of the invention with reference to the attached drawings.

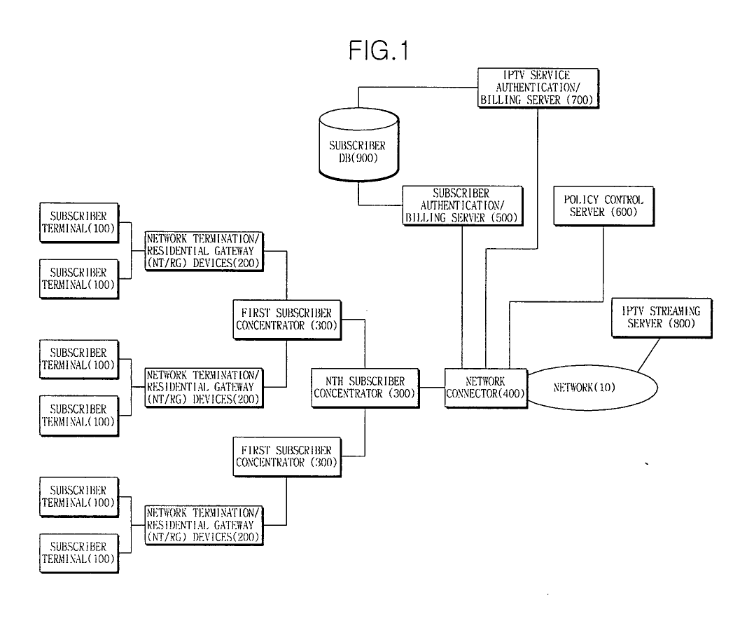

FIG. 1 shows a schematic configuration of a network related to the present invention. Referring to FIG. 1, the network includes a plurality of subscriber terminals 100, a plurality of network termination/residential gateway (NT/RG) devices 200 and a plurality of subscriber concentrators 300. The subscriber terminals 100 may be wired or wireless terminals. A wired terminal may be a home terminal such as a personal computer (PC), a set-top box, or a VoIP phone, and a wireless terminal may be a home or external terminal such as PC or personal digital assistant (PDA) which is connected through a wireless communication interface, for example, a WiFi interface. The subscriber terminals 100 are connected to a subscriber concentrator 300 through the NT/RG device 200 such as a modem or a home gateway.

The subscriber concentrators 300 may be switch devices including a digital subscriber line access multiplexer (DSLAM), such as asymmetric digital subscriber line (ADSL) and very-high data rate digital subscriber line (VDSL), and a fast Ethernet switch (FES), and more than one device can be used as the subscriber concentrators 300 as shown in FIG. 1.

Each subscriber concentrator 300 connects with the subscriber terminals 100, and concentrates traffic from the subscriber terminals 100 and sends the traffic to a metro network 10. Furthermore, the subscriber concentrators 300 act as dynamic host configuration protocol (DHCP) relay agents in the course of DHCP processing.

The network connector 400 may be a broadband remote access server (BRAS) that manages subscribers, assigns an IP address, and provides a subscriber service. The network connector 400 has a DHCP proxy or a relay function and acts as an AAA client for authentication.

A network from the NT/RG devices 200 to the network connector 400 through the subscriber concentrators 300 is referred to as an access network. Also, these elements of the access network belong to a network transmission layer. The access network performs IP allocation and service control for the subscriber terminals 100 to connect and communicate with the network through a variety of interfaces, passes traffic received from the subscriber terminals 100 to the network, and transmits the traffic sent from the network to a corresponding subscriber terminal 100.

In view of IGMP processing for IPTV service in the access network, the network connector 400 interworks with multicast routing while functioning as an IGMP router, and the first subscriber concentrators 300 perform a traffic control function for the subscriber IPTV multicast stream while functioning as IGMP snoopers.

A network control layer which controls the access network includes a subscriber authentication/billing server 500 which authenticates network access of a subscriber and bills the subscriber for the network access, and a policy control server 600 which determines network policies to be applied to the subscriber and performs management of network resource and service control. Also, the network control layer includes storage to store information regarding subscriber authentication status and subscriber network connection status, and the storage may be implemented as an additional subscriber database (DB) 900, or be provided in the same system as the subscriber authentication/billing server 500.

A service control layer that controls various services on the network includes an IPTV service authentication/billing server 700 which processes authentication and billing for the IPTV services. The IPTV service authentication/billing server 700 processes authentication and billing inquiries for the IPTV services while interworking with devices on the access network and devices on the network control layer.

An IPTV streaming server 800, which is installed on an edge or at a predetermined position of the network 10, transmits an IPTV multicast stream of each channel to the network 10. The IPTV multicast stream transmitted to the network 10 is transferred to the access network through the use of multicast routing protocol between the network 10 and the network connector 400, and then the IPTV multicast stream passes through the IGMP snooper, the IGMP router, and the access network, and then reaches the subscriber terminals 100.

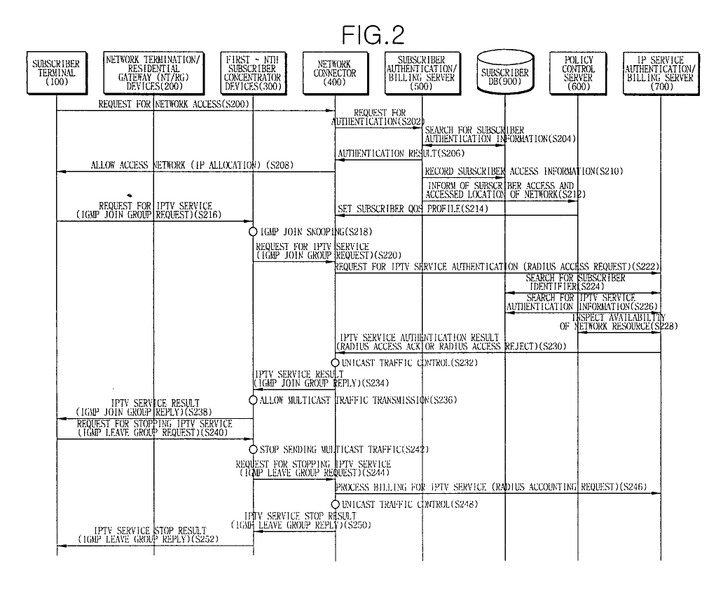

FIG. 2 is a diagram showing the whole procedure of how to perform IPTV service authentication and service quality control in the network in FIG. 1 according to an embodiment of the present invention.

The user terminal 100 requests authentication for access to the network 10 through an access interface in a variety of forms such as PPP, DHCP, 802.1x and so on, and protocol (operation S200), and the network connector 400 receives the request and issues a request for authentication to the subscriber authentication/billing server 500 (operation S202). The subscriber authentication/billing server 500 interworks with the subscriber database 900 to determine whether a subscriber is authorized to access to the network 10 (operation S204). Here, the subscriber database 900 may be provided as a part of the subscriber authentication/billing server 500 or may be provided externally.

The subscriber authentication/billing server 500 transmits the result of verifying the network access authentication to the network connector 400 (operation S206). When the network access is authenticated, the network connector 400 allocates an IP address to the subscriber terminal 100 and allows the subscriber to access to the network 10 (operation S208). In operation S208, the network connector 400 may use its own IP pool or interwork with the external DHCP server so as to allocate the network-accessible IP address to the subscriber.

Meanwhile, the status of the subscriber's access to the network and information regarding the allocated IP address are stored in the subscriber database 900 by the subscriber authentication/billing server 500. Also, the subscriber authentication/billing server 500 transmits information, which indicates whether a subscriber accesses to the network 10 and at which position the subscriber accesses, to the policy control server 600 so that the policy control server 600 can begin managing resources with regard to the subscribers (operation S212). The policy control server 600 controls the network connector 400 to set a subscriber QoS profile appropriate to the subscriber, who is accessing to the network 10 (operation S214).

When the subscriber designates a specific multicast group address, the subscriber terminal 100 receives an IGMP join group request message and issues a request for an IPTV service (operation S216). The IGMP join group request message is snooped (operation S218), passing through the first subscriber concentrator 300, and is transmitted to the network connector 400 acting as an IGMP router (operation S220). The network connector 400 that has received the IGMP join group request generates a RADIUS access request message in compliance with RADIUS protocol, and transmits the RADIUS access request message to the IPTV authentication/billing server 700 to request the IPTV service authentication for the corresponding subscriber (operation 222).

According to an embodiment of the present invention, the network connector 400 includes pieces of information regarding a source IP address of the subscriber, which has received the IGMP join group request message, and a multicast group IP address in the RADIUS access request message. In the IPTV service authentication/billing server 700, the pieces of address information are required for the IPTV service authentication for the subscriber. The network connector 400 may issues a request for IPTV service authentication by providing such the address information without any particular identifiers for the authentication.

Additionally, information regarding an IP address of the subscriber authentication/billing server 500 is stored in the network connector 400 as setting information, and the network connector 400 may further include this address information in the RADIUS access request message. By doing this, the network connector 400 can transmit the IP address information of the subscriber authentication/billing server 500, which is to be interworked with the IPTV service authentication/billing server 700, in order to detect an identifier of the subscriber which requests the IPTV service.

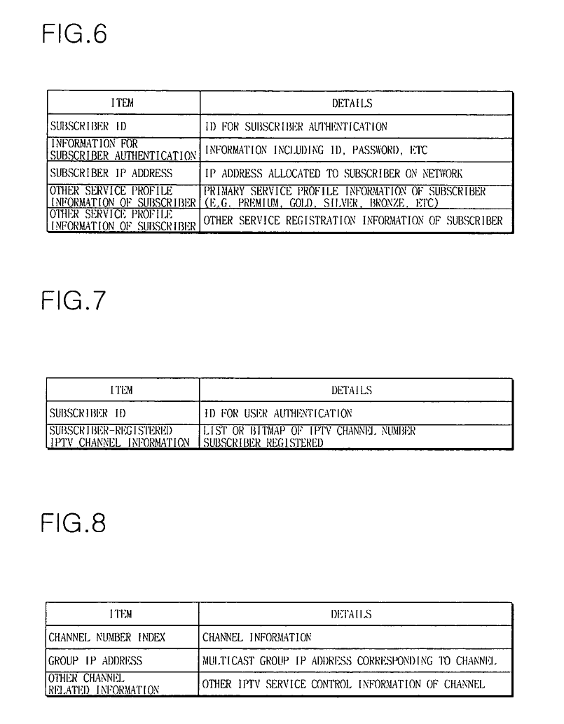

The IPTV service authentication/billing server 700 receives the RADIUS access request message from the network connector 400, and extracts the subscriber source IP address, the group IP address and the IP address of the subscriber authentication/billing server 500 from the received message. The IPTV service authentication/billing server 700 searches for identifier information of the subscriber from a subscriber management table, as shown in FIG. 6, in the subscriber database 900, with reference to the subscriber source IP address, while interworking with the subscriber authentication/billing server 500 that is confirmed by the extracted IP address (operation S224).

Also, the IPTV service authentication/billing server 700 searches for an IPTV channel information, which corresponds to the extracted group IP address, from an IPTV service management table for each subscriber, as shown in FIG. 7, and investigates whether the subscriber is permitted to use the service from the corresponding channel by searching through a channel-group address mapping table, as shown in FIG. 8, based on the user identification information and the channel information (operation S226). If the subscriber is permitted to use the service of the corresponding channel, the IPTV service authentication/billing server 700 investigates whether a network source is available to provide the IPTV service through the policy control server 600 (operation S228).

For reference, the tables shown in FIGS. 6 to 8 may be managed as a whole in the subscriber database 900, or the subscriber management table may be managed only by the subscriber database 900 and the IPTV service management table for each subscriber and the channel-group address mapping table may be managed by an additional storage. For example, the IPTV service management table for each subscriber and the channel-group address mapping table may be managed directly by the IPTV service authentication/billing server 700. The storage for storing the above-mentioned data tables and managers that manage the data tables can be changed according to system operating methods.

When the IPTV service authentication succeeds and the network resource is available, the IPTV service authentication/billing server 700 transmits a RADIUS access ack message to the network connector 400 in order to notify of authentication success for the IPTV service (operation S230). In contrary, when IPTV service authentication fails or the network resource is not available, the IPTV service authentication/billing server 700 sends a RADIUS access reject message to the network connector 400 to notify of the authentication failure for the IPTV service (operation S230).

The network connector 400 may be informed of the IPTV service authentication success by receiving the RADIUS access ack message, or informed of the IPTV service authentication failure by receiving the RADIUS access reject message. When receiving the RADIUS access ack message, the network connector 400 narrow a transmission band of normal unicast traffic that is allocated to the subscriber to the size of a band of the successfully authenticated IPTV multicast traffic (operation S232). This is for preventing the unicast traffic from being damaged by multicast traffic that will be added to the unicast traffic in the subscriber concentrator 300 acting as the IGMP snooper.

Furthermore, the network connector 400 delivers the IPTV service authentication result to the subscriber concentrator 300. According to the characteristics of the present invention, the network connector 400 notifies the subscriber concentrator 300 of the IPTV service authentication result using Internet group management protocol (IGMP). In the current embodiment of the present invention, the network connector 400 generates an IGMP group reply message and transmits it to the subscriber concentrator 300 to inform of the IPTV service authentication result (operation S234). The IGMP group reply message has a code field in which a value indicating the request is granted (hereinafter, referred to as “request granted” value) is written when the authentication succeeds or a value indicating the request is denied (hereinafter, referred to as “request denied” value) is written when the authentication fails.

The first concentrator 300 receives the IGMP join group reply message from the network connector 400 and inspects the code filed of the IGMP join group reply message, and transmits a stream of a multicast group to the subscriber terminal 100 when the code field has the “request granted” value (operation S236). When the code field has the “request denied” value, the first concentrator 300 does not transmit a stream of a multicast group to the subscriber terminal 100. Also, the first subscriber concentrator 300 delivers the IGMP join group reply message from the network connector 400 to the subscriber terminal 100 to inform of the IPTV service request result (operation S238).

Meanwhile, when the subscriber terminal 100 sends an IGMP leave group message to the first subscriber concentrator 300 to request to stop offering the IPTV service while using the IPTV service (operation S240), the first subscriber concentrator 300 stops transmitting the multicast stream to the subscriber terminal 100 (operation S242), and then delivers the received IGMP leave group request message to the network connector 400 (operation S244).

The network connector 400 receives the IGMP leave group request message, generates a charge message in accordance with the RADIUS protocol, and transmits the charge message to the IPTV service authentication/billing server 700. In the current embodiment of the present invention, the network connector 400 sets the time at which the IGMP join group reply is processed as the IPTV service start time and the time at which the IGMP leave group request message is processed as an IPTV service end time, creates a RADIUS accounting request charge message based on the IPTV service start time and the IPTV service end time, and then sends the created message to the IPTV service authentication/billing server 700 so that the IPTV service authentication/billing server 700 can charge the corresponding subscriber for the IPTV service (operation S246). More preferably, the network connector 400 recovers the size of the transmission band of the unicast traffic which has been narrowed in operation S232 (operation S248). Furthermore, the network connector 400 generates an IGMP leave group reply message and sends it to the subscriber concentrator 300 (operation S250), and the subscriber concentrator 300 which receives the message delivers the IGMP leave group reply message to the subscriber terminal 100 to inform that the IPTV service delivery has been successfully stopped (operation S252).

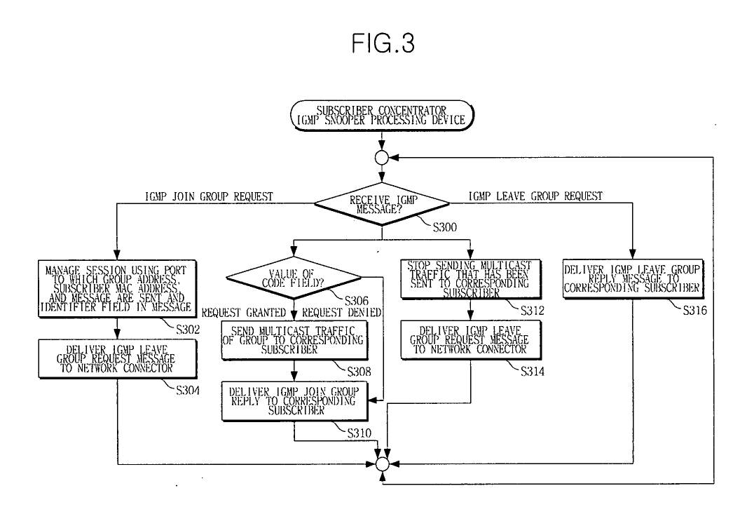

An IPTV service method will be described below from a viewpoint of each of the subscriber concentrator 300, the network connector 400 and the IPTV service authentication/billing server 700 with reference to FIGS. 3 to 5 in conjunction with FIG. 1.

The subscriber concentrator 300 receives and verifies the IGMP message (operation S300). If the message is verified as an IPTV join group request message that has been sent from the subscriber terminal 100, the subscriber concentrator 300 manages an IPTV service request session using an MAC address of the corresponding subscriber, a requested port, an address of the requested group, and an identifier in the message (operation S302), and delivers the received message to the network connector 400 (operation S304).

If the message is an IGMP join group reply message, the subscriber concentrator 300 searches for a value written in the massage (operation S306), and if the value is “request granted”, a multicast stream that has been requested to a corresponding IPTV request session is sent to the subscriber terminal 100 (operation S308). If the value in the message is “request denied”, the multicast stream is not sent to the subscriber terminal 100 (operation S310).

When receiving an IGMP group request message, the subscriber concentrator 300 stops sending the multicast stream to the corresponding subscriber terminal 100 (operation S312) and delivers the received message to the network connector 400 (operation S314). When receiving an IGMP leave group reply message from the network connector 400 in response, the subscriber concentrator 300 delivers the IGMP leave group reply message to the corresponding subscriber terminal 100 (operation S316).

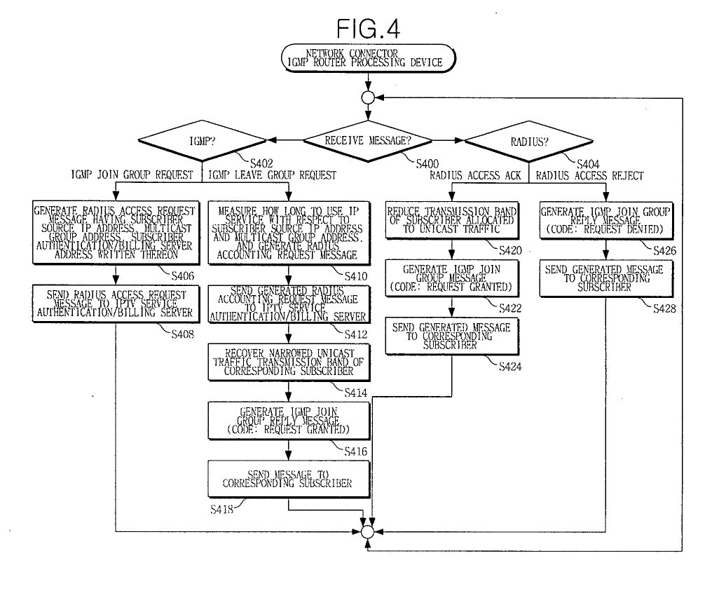

FIG. 4 is a flowchart illustrating how the network connector which acts as an IGMP router authenticates and controls IPTV service quality according to an embodiment of the present invention.

The network connector 400 receives a message (operation S400), and checks if the received message is an IGMP message (operation S402) or a RADIUS message (operation S404). When the received message is an IGMP join group message, the network connector 400 generates a RADIUS access request message, which has a source IP address of a packet, a multicast group IP address, a subscriber authentication/billing server IP address and an access network policy control server IP address written thereon (operation S406), and sends the generated message to the IPTV service authentication/billing server 700 (operation S408).

When receiving an IGMP leave group request message, the network connector 400 measures the time for how long the IPTV service has been provided and how much traffic has been sent to the user terminal 100 with respect to the user source IP address and the multicast group IP address, and generates a RADIUS accounting request message that has the measurement result written thereon (operation S410). Then, the corresponding subscriber terminal 100 recovers the size of the transmission traffic which has been reduced to the size of the unicast traffic allocated to the subscriber terminal 100 (operation S414). Moreover, the network connector 400 generates an IGMP leave group message that has a code field in which “request granted” is written (operation S416), and sends the generated message to the subscriber terminal 100 to inform that the subscriber terminal 100 has successfully stopped receiving the IPTV service (operation S418).

When receiving a RADIUS ack message, which indicates acknowledgement of the IPTV service, in response to the RADIUS access request message, the network connector 400 narrows the transmission band, which has been set for the unicast traffic, to a width of a requested multicast traffic if a traffic band currently available to the subscriber terminal 100 is not wide enough to accommodate the requested multicast traffic (operation S420). This is for preventing traffic crash which may be caused by IPTV multicast streams. Furthermore, the network connector 400 generates an IGMP join group reply message that has “request granted” written on its code field (operation S422), and sends the generated message to the subscriber concentrator 300 to deliver the message to the subscriber terminal 100 (operation S424). As the result, the subscriber can be notified that the IPTV service authentication succeeded.

If the network connector 400 receives a RADIUS access reject message, which means the IPTV service is rejected to be provided, in response to the RADIUS access request message, the network connector 400 generates an IGMP join group reply message that has “request denied” value set in its code field (operation S426), and sends the generated message to the subscriber concentrator 300 to deliver the message to the subscriber terminal 100 (operation S428). Consequently, the subscriber can be notified that the IPTV service authentication failed.

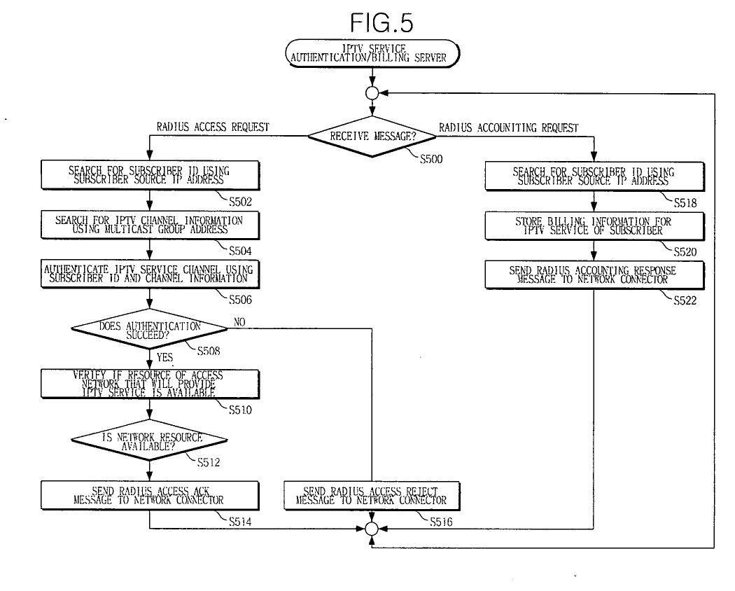

FIG. 5 is a flowchart illustrating how the IPTV service authentication/billing server 700 processes the IPTV service authentication and the IPTV service quality control according to an embodiment of the present invention.

The IPTV service authentication/billing server 700 receives and verifies a RADIUS message sent from the network connector 400 (operation S500). When receiving a RADIUS access request message for authentication request for the IPTV service, the IPTV service authentication/billing server 700 extracts a subscriber source IP address from the RADIUS access request message and searches for identification information of the subscriber, interworking with the subscriber authentication/billing server 500 (operation S502). In this procedure, the IPTV service authentication/billing server may search for the identification information not by interworking with the subscriber authentication/billing server 500, but by directly searching a subscriber management table as shown in FIG. 6, according to an operating system. The IPTV service authentication/billing server 700 extracts a multicast group IP address from the received RADIUS message and searches for a corresponding channel information from a service channel-group address mapping table as shown in FIG. 7 (operation S504). Then, the IPTV service authentication/billing server 700 searches the IPTV service management table, as shown in FIG. 8, using the searched identification information and channel information, and determines whether the subscriber is authorized to access to an IPTV channel (operation S506).

If the subscriber is authorized to access to the corresponding IPTV channel (operation S508), the IPTV service authentication/billing server 700 interworks with the policy control server 600 to verify if the network resource is available (operation S510). When the network resource is available to the subscriber (operation S512), the IPTV service authentication/billing server 700 sends a RADIUS access ack message to the network connector 400 to notify that authentication of the IPTV service succeeds (operation S514). If the subscriber is not allowed to access to the IPTV channel or the network resource is not available to the subscriber (operation S512), the IPTV service authentication/billing server 700 sends a RADIUS access reject message to the network connector 400 to inform that authentication of the IPTV service fails (operation S516).

Meanwhile, if the received RADIUS message is a RADIUS accounting request message, the IPTV service authentication/billing server 700 extracts the IP address of the subscriber terminal 100 from the received message by interworking with the subscriber authentication/billing server 500 and searches for the identification information either by interworking with the subscriber authentication/billing server 400 or directly searching the subscriber management table (operation S518). Then, the IPTV service authentication/billing server 700 stores accounting information for the found subscriber at a predetermined location (operation S520), and sends a RADIUS accounting response message to the network connector 400 to inform that the billing has been successfully done (operation S522).

For information, some of operations describe above are not necessarily to be done in the order as explained in the above embodiments. For example, operations S308 and S310 which depend on the result of operation S306 in FIG. 3 can be performed reversely. In other words, the order of performing operations which are to be done if predetermined conditions are met can be changed when there is no relation between the operations.

According to the present invention, a technical solution is provided, which authenticates an IPTV service using RADIUS technology, which has been favored by the International standard, and controls traffic flow with respect to an IPTV service authenticated by the use of IGMP that is widely used in a common network. Accordingly, the control of the IPTV service authentication and service quality is available, and consequently, access network resources can be used efficiently.

It is expected that market demand for the IPTV service which is a broadcasting service over an IP packet network will be increased so drastically that there is a need of a technology which can be immediately applied to the market without replacing the existing devices while using most efficiently the access network resources having high traffic concentration. As the solution of the need described above, the IPTV service authentication and service control technology according to the present invention will enable the implementation of an IPTV service control model which can be practically employed to a network.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An Internet protocol television (IPTV) service method which is performed by a network connector that is a part of an access network, the IPTV service method comprising:
receiving an IPTV service request message from a subscriber;
generating an IPTV service authentication request message using a RADIUS protocol in response to the IPTV service request message;
requesting IPTV authentication by sending the generated IPTV service authentication request message to an IPTV service authentication/billing server according to the RADIUS protocol; and
receiving an IPTV service authentication response message from the IPTV service authentication/billing server according to the RADIUS protocol in response to the authentication request.

2. The IPTV service method of claim 1, wherein the generating of the IPTV service authentication request message comprises: including a source IP address of a subscriber and a multicast group IP address, which are written in the IPTV service request message, in the IPTV service authentication request message.

3. The IPTV service method of claim 2, wherein the message generating of the IPTV service authentication request comprises: including a subscriber authentication/billing server IP address stored in the network connector in the IPTV service authentication request message.

4. The IPTV service method of claim 1, further comprising:
narrowing a transmission band of unicast traffic that is allocated to a corresponding subscriber when the IPTV service authentication/billing server sends a message indicating that IPTV service authentication succeeds.

5. The IPTV service method of claim 4, wherein in the narrowing of the transmission band of unicast traffic, the transmission band is narrowed to a width of a band of the authenticated IPTV multicast traffic.

6. The IPTV service method of claim 1, further comprising:
informing a subscriber concentrator of the authentication result of the received IPTV service authentication reply message using Internet group management protocol (IGMP).

7. The IPTV service method of claim 6, further comprising:
receiving an IPTV service stop request message from a subscriber;
collecting accounting information for the corresponding subscriber;
generating an accounting message including the collected accounting information using RADIUS protocol; and
requesting the IPTV service authentication/billing server to process billing by sending the generated accounting message according to the RADIUS protocol.

8. The IPTV service method of claim 7, wherein the accounting information includes IPTV service time information which indicates a period of the between the time at which the IPTV service request message is processed and the time at which the IPTV service stop request message is processed.

9. The IPTV service method of claim 7, further comprising:
recovering the narrowed transmission band of the unicast traffic to the original width when the IPTV service stop request message is received.

10. An IPTV service method which is performed by an IPTV service authentication/billing server that performs subscriber authentication and billing process for an IPTV service, the IPTV service method comprising:
receiving an IPTV service authentication request message which is generated using RADIUS protocol and sent from a network connector;
determining whether the subscriber is authorized for the IPTV service in response to the IPTV service authentication request of the received message; and
sending the determined authentication result to the network connector using the RADIUS protocol.

11. The IPTV service method of claim 10, wherein the determining whether the subscriber is authorized comprises identifying a subscriber that requests the IPTV service; searching for a channel information of the IPTV service that is quested to be authenticated; and determining whether the subscriber is authorized for the IPTV service by searching an IPTV service usage right relating information table based on subscriber identification information and the searched channel information.

12. The IPTV service method of claim 11, wherein the identifying of the subscriber comprises: extracting an IP address of a subscriber authentication/billing server from the received IPTV service authentication request message; extracting a subscriber source IP address from the received message; and delivering the extracted subscriber source IP address to the subscriber authentication/billing server using the extracted IP address of the subscriber authentication/billing server and receiving the subscriber identification information in response to the delivery of the extracted subscriber source IP address.

13. The IPTV service method of claim 11, wherein the searching of the channel information comprises: extracting a multicast group IP address from the received IPTV service authentication request message; and searching a channel-group address mapping table for channel information corresponding to the extracted multicast group IP address.

14. An IPTV service method which is performed by a subscriber concentrator that is a part of an access network, the IPTV service comprising:
receiving an IPTV service authentication reply message generated using an Internet group management protocol (IGMP) from a network connector;
analyzing the received IPTV service authentication reply message;
sending a corresponding IPTV multicast stream to a corresponding subscriber terminal when the analyzed message indicates authentication success; and
stopping the corresponding IPTV multicast stream from being sent to the corresponding subscriber terminal when the analyzed message indicates authentication failure.

15. An IPTV service system comprising:
a subscriber concentrator which delivers an IPTV service request message that is sent from a subscriber terminal, receives an IPTV service authentication reply message generated in accordance with IGMP in response to the IPTV service request message, and sends a corresponding IPTV multicast stream to the subscriber terminal according to an IPTV service authentication result;
a network connector which receives the IPTV service request message delivered from the subscriber concentrator, generates an IPTV service authentication request message in accordance with a RADIUS protocol, sends the generated IPTV service authentication request message to an IPTV service authentication/billing server, generates an IPTV service authentication reply message in accordance with the IGMP when receiving an IPTV service authentication reply message generated in accordance with the RADIUS protocol, and sends the generated IPTV service authentication reply message to the subscriber concentrator; and
the IPTV service authentication/billing server which determines whether the subscriber is authorized for an IPTV service when receiving the IPTV service authentication request message that is generated in accordance with the RADIUS protocol and sent from the network connector, and generates the IPTV service authentication reply message in accordance with the RADIUS protocol and sends the IPTV service authentication reply message to the network connector.

16. The IPTV service system of claim 15, wherein the subscriber concentrator delivers an IPTV service stop request message from the subscriber terminal to the network connector, and the network connector collects billing information with regard to the corresponding subscriber and generates an accounting message, which reflects the billing information, in accordance with the RADIUS protocol and sends the accounting message to the IPTV service authentication/billing server when receiving the IPTV service stop request message from the subscriber concentrator.
